(19) United States
(12) Patent Application Publication
(10) Pub. No.: US 2022/0007807 A1
(43) Pub. Date: Jan. 13, 2022

(54) HAIR CARE APPARATUS

(71) Applicant: SANFAT ELECTRIC MANUFACTURING COMPANY LIMITED, Kowloon, Hong Kong (CN)

(72) Inventors: Yasuo TOTSUKA, Dongguan City, Guangdong (CN); Masanori TERAMOTO, Dongguan City, Guangdong (CN); Keitoku MORITA, Dongguan City, Guangdong (CN); MingFeng YANG, Dongguan City, Guangdong (CN)

(21) Appl. No.: 17/295,783

(22) PCT Filed: Nov. 23, 2018
(86) PCT No.: PCT/CN2018/117105

§ 371 Date: May 20, 2021

(51) Int. Cl. A45D 1/04; A45D 2/00; B01J 20/18; B01J 20/28

(52) U.S. Cl. CPC A45D 1/04; A45D 2/001; A45D 2001/008; B01J 20/2805; B01J 20/18

(57) ABSTRACT

A curl iron, which is an example of the hair care apparatus of the present invention, includes a holding member, a first pinching member and a second pinching member 16, 18 for sandwiching hair, a desiccant holding container 12, a reproducible desiccant 10 held in the desiccant holding container 12, and a heater 14. The heater 14 is arranged on the hair treatment surface of the desiccant holding container 12 in the longitudinal direction of the desiccant holding container 12. The desiccant 10 is granular. The desiccant holding container 12 has a plurality of holes through which the desiccant 10 and debris of the desiccant cannot pass. The desiccant 10 heated by the heater 14 releases moisture absorbed by the desiccant 10. This moisture is arranged to the user's hair together with the air heated by the heater 14 through the plurality of holes and the air vent opening of the desiccant holding container 12.

### TECHNICAL FIELD

The present invention relates to a hair care apparatus capable of supplying moisture generated from a desiccant to hair, particularly a hair iron.

### BACKGROUND ART

Hair care apparatuses such as hair dryers, hair irons, and roll brushes blow hot air heated by a heater onto hair for drying the hair, or apply heated pinching members directly to the hair so as to be shaped like wavy, curl or straight. However, since the hair care apparatuses use heat, they damage the hair. In particular, in the case of a hair iron, the hair is sandwiched between two pinching members held at a high temperature (120° C. to 200° C.), and is heated instantly by high-temperature heat-generating portions. That is, in the case of the hair iron, since the high-heated pinching member directly touches the hair, the hair can be strongly damaged by repeated hair styling. Hair damage is the greatest cause of loss of luster and strength in body of the hair, widening of the hair, and poor cohesion of habitual hair. Therefore, when using the hair iron, it is important to moisturize the hair, that is, to supply moisture to the hair in order to prevent hair damage.

Conventionally, for various hair care apparatuses it has been trying to supply moisture to hair. For example, the patent document 1 discloses a warm air dryer where adsorbent can be easily maintained, and it is possible to switch between the state where warm air is fed in a dry state and the state where warm air is fed in a humidified state without inviting an increase in size of the warm air dryer. In this warm air dryer, air from the outside is heated by a heater, and the heated air is fed to the feeding path as dry warm air by a blower fan. A nozzle for blowing out the dry warm air is attached to the tip of the feeding path. An adsorbent made of silica gel or the like for adsorbing and holding moisture is arranged in the nozzle. The adsorbent adsorbs and retains moisture during a period other than when feeding the dry warm air, and releases the adsorbed moisture when feeding the dry warm air, so that it is possible to supply the moisture to the hair. As a result, the warm air dryer disclosed in the patent document 1 can eliminate the work of storing water in the water tank, which is necessary for the conventional apparatus.

The patent document 2 discloses a hair iron comprising a heater, a blower fan, a first pinching member, a second pinching member, and a reproducible desiccant, wherein the desiccant is arranged adjacent to both sides of the heater in the longitudinal direction of the heater. Zeolite, alumina, silica, silica gel and the like are used as the desiccant. The heater heats the air blown by the blower fan, and the desiccant heated by the heater releases moisture. The desiccant absorbs 20% by weight of moisture in 24 hours and releases moisture when heated by the heater, allowing to supply moisture to the hair for 60 minutes with a single use. As a result, the user can use the hair iron every day without performing the work of storing water in the water tank which is required for the conventional apparatus.

### PRIOR ART DOCUMENT

### Patent Document

[Patent Document 1] Japanese Unexamined Patent Publication No. 2008-54769

[Patent Document 2] Japanese Patent No. 6091482

### SUMMARY OF INVENTION

### Technical Problem

The warm air dryer of the patent document 1 feeds most of the outside air (fed air) which is sucked into a main body case from a suction port by the rotational movement of the blower fan, to the air vent opening through the feed path which is formed inside the air guide cylinder and the insulation cylinder. The air is heated by the heater while passing through the feed path, and fed as dry warm air (see paragraph 0027). That is, the warm air dryer of the patent document 1 requires the blower fan in order to take in the outside air from the suction port and to supply the dry warm air heated by the heater to the air vent opening. Using the blower fan in the hair care apparatus such as a warm air dryer causes the problem of making noise, consuming power, and necessity to secure its housing space in the hair care apparatus.

The hair iron of the patent document 2 also takes in air from the air vent opening by the blower fan, sends to the heater through the ventilation pipe, and supplies the moisture released from the desiccant heated by the heater to the hair from a plurality of air outlets (see paragraph 0026). As described above, the hair iron of the patent document 2 also causes the above-mentioned problems of the patent document 1. Further, in the hair iron of the patent document 2, as shown in the cross-sectional view of B-B′ in FIG. 5, the desiccant held in the desiccant holding member 12b is exposed. Therefore, if the desiccant is chipped, it causes a problem that the chipped debris passes through air vent openings 28 and adheres to the user's hair.

An object of the present invention is to provide a hair care apparatus that solves such a problem caused by using a blower fan for a hair care apparatus and a problem that debris of a desiccant adheres to a user's hair.

### Solution to Problem

The above problem is solved by the hair care apparatus of the present invention comprising a first pinching member and a second pinching member for sandwiching hair, a desiccant holding container, a reproducible desiccant held in the desiccant holding container, and a heater, wherein the heater is arranged on the hair treatment surface side of the desiccant holding container in the longitudinal direction of the desiccant holding container, the desiccant is granular, and a plurality of holes through which the desiccant and fragments of the desiccant cannot pass are arranged on the entire surface of the desiccant holding container.

In the case of the hair iron of the patent document 2, if the blower fan was removed, the hair iron could not be practically used. That is, in the hair iron of the patent document 2, the heater is arranged in the center of the first pinching member of the hair iron, and the desiccant is held by the container whose part is open. Because of this construction such hair iron has a problem that it takes a long time for the first pinching member to reach the practical temperature after the heater is switched on, and that the moisture emitted from the desiccant is already wasted before the first pinching member reaches the practical temperature.

In contrast, in the hair care apparatus of the present invention, a heater is arranged on the hair treatment surface side of the desiccant holding container in the longitudinal direction of the desiccant holding container. In the case of a curl iron, the hair treatment surface is a curved surface composed of an outer peripheral surface of the first pinching member and the second pinching member around which the user's hair is rolled, while in the case of a straight iron, the hair treatment surface is a plane on which the user's hair is sandwiched by the first pinching member and the second pinching member. Further, the desiccant holding container has a plurality of holes through which the desiccant and debris of the desiccant cannot pass, and the desiccant is granular. Since the heater is arranged on the hair treatment surface side of the desiccant holding container in the longitudinal direction of the desiccant holding container, the heat of the heater is immediately transferred to the hair treatment surface and the desiccant holding container after the heater is switched on, so that the hair care apparatus reaches the practical temperature in a sufficiently short time. Further, since the desiccant is granular, the total surface area of the desiccant is increased, and since the desiccant holding container is provided with a plurality of holes, the desiccant generates more moisture in a short time. Thus, after the heater is switched on, the hair treatment surface reaches the practical temperature in a short time, and the desiccant does not wastefully release moisture by the time the hair treatment surface reaches the practical temperature. As a result, the hair care apparatus of the present invention can be practically used even though it does not have a blower fan.

In the hair care apparatus of the present invention, the desiccant holding container may further comprise a stainless mesh. By forming the desiccant holding container with a stainless mesh, it is possible to more reliably prevent the desiccant and the debris of the desiccant from passing through.

In the hair care apparatus of the present invention, the desiccant holding container may be made of stainless mesh or punching metal. In the present invention, the punching metal refers to a metal plate in which holes are formed by press working, etching treatment (chemical treatment), laser processing, or the like. By forming the desiccant holding container with the stainless mesh or punching metal, it is possible to more reliably prevent the desiccant and the debris of the desiccant from passing through.

In the hair care apparatus of the present invention, the particle size of the desiccant may be 1.4 to 2.5 mm. This enables to more reliably prevent the desiccant particles and debris of the desiccant particles from passing through the desiccant holding container, and to improve the heat conversion efficiency to the desiccant.

In the hair care apparatus of the present invention, the heater may be projected from the desiccant container. As a result, it is possible to shorten the time from the heater is switched on until the first pinching member reaches the practical temperature.

In the hair care apparatus of the present invention, the desiccant may comprise zeolite.

In the hair care apparatus of the present invention, the desiccant may comprise alumina and silica.

In the hair care apparatus of the present invention, the desiccant may comprise silica gel.

In the hair care apparatus of the present invention, the desiccant may comprise a clay-based desiccant.

The hair care apparatus of the present invention may be set so that the temperature of the desiccant is 150° C. or higher at the time of use. This enables to efficiently generate moisture from the desiccant.

The hair care apparatus of the present invention may be a curl iron.

The hair care apparatus of the present invention may be a straight iron in which the desiccant holding container and the heater are arranged in the first pinching member and the second pinching member, respectively.

### BRIEF DESCRIPTION OF DRAWINGS

FIG. 1 is a perspective view of the curl iron of the present invention.

FIG. 2 is a front view, a left side view, and a rear view of the curl iron of the present invention.

FIG. 3 is a left side view of the curl iron of the present invention.

FIG. 4 is a cross-sectional view AA of the curl iron of the present invention in FIG. 3.

FIG. 5 is a cross-sectional view BB of the curl iron of the present invention in FIG. 3.

FIG. 6 is a cross-sectional view CC of the curl iron of the present invention in FIG. 3.

FIG. 7 is a top view of the curl iron of the present invention.

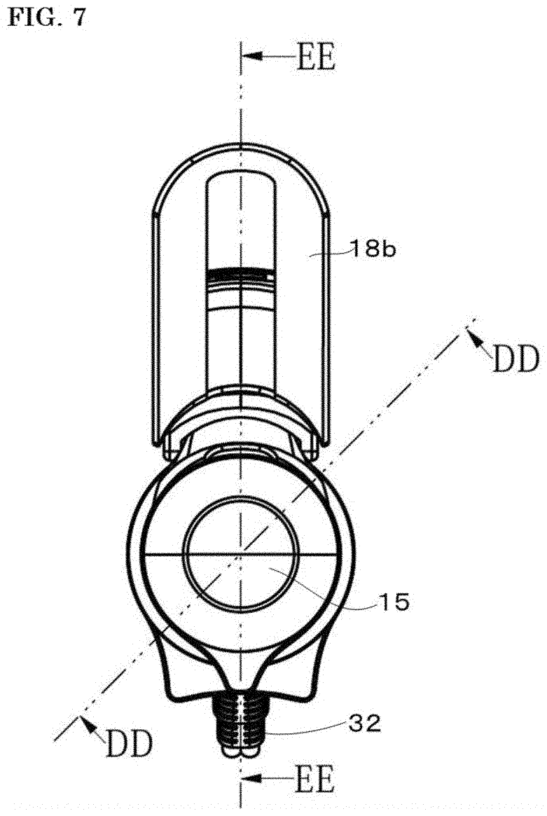

FIG. 8 is a cross-sectional view DD of the curl iron of the present invention in FIG. 7.

FIG. 9 is a cross-sectional view EE of the curl iron of the present invention in FIG. 7.

FIG. 10 is a cross-sectional view showing the relation among the desiccant, the desiccant holding container, and the heater of the curl iron of the present invention.

FIG. 11 is a perspective view showing a cross section of the first pinching member of the curl iron of the present invention.

FIG. 12 is an enlarged perspective view showing a desiccant holding container for the curl iron of the present invention.

FIG. 13 is a diagram showing a discharge amount of the curl iron of the present invention.

FIG. 14 is a diagram showing a temperature rise of the curl iron of the present invention.

FIG. 15 is a diagram showing a usage mode of the curl iron of the present invention.

FIG. 16 is a front view and a right side view of the straight iron of the present invention.

FIG. 17 is a cross-sectional view AA and BB of the straight iron of the present invention in FIG. 16.

FIG. 18 is a cross-sectional view CC of the straight iron of the present invention in FIG. 16 A.

### DESCRIPTION OF EMBODIMENTS

### Embodiment 1

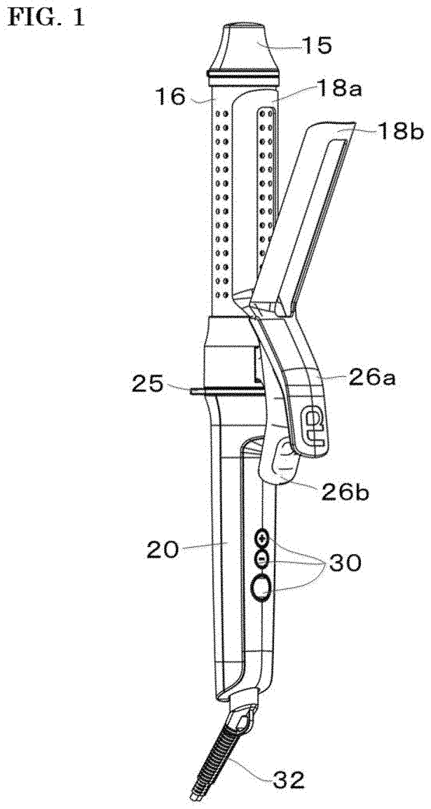

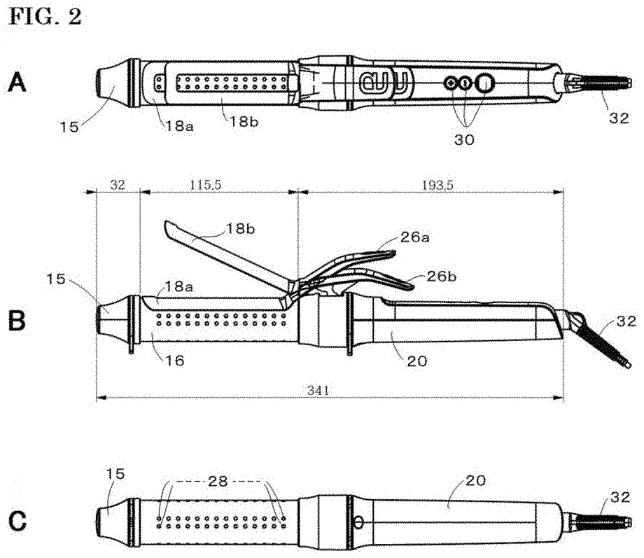

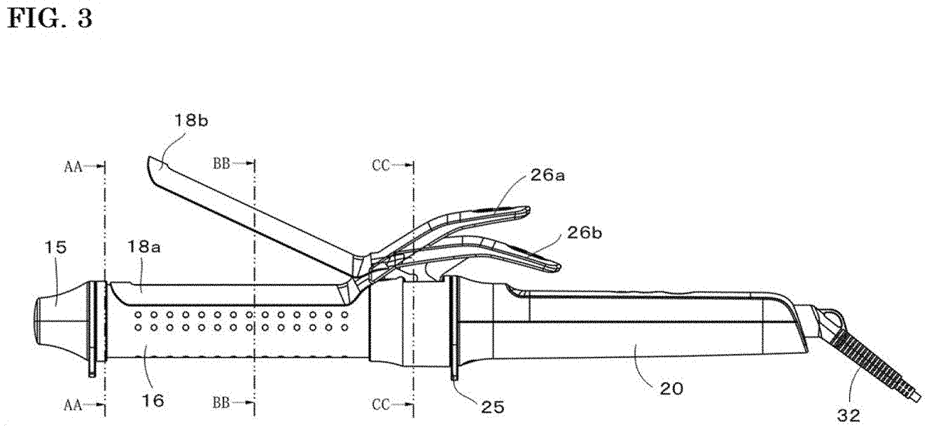

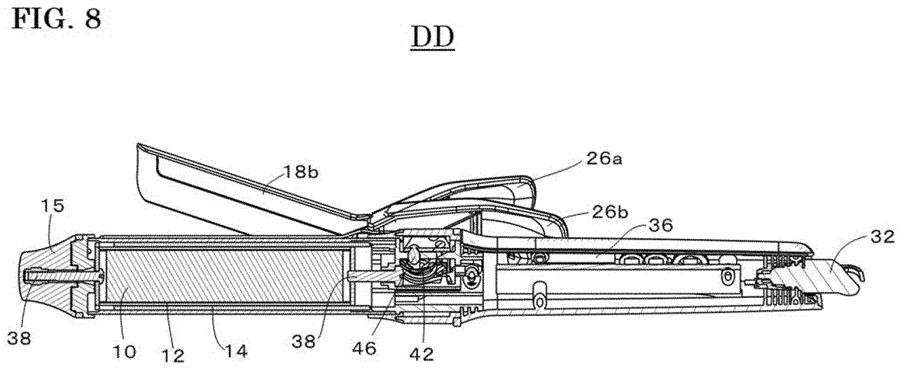

An example of the hair care apparatus of the present invention will be described as a curl iron below. In the present application, the upper part (lower part) of the curl iron (the hair care apparatus) means the upper part (lower part) of the curl iron shown in FIG. 1. As shown in the overall perspective view (FIG. 1), the left side view (FIG. 2 B), the rear view (FIG. 2 C), the front view (FIG. 2 A) and FIG. 3, the curl iron includes a holding member 20 held by a user, a first pinching member 16 arranged above the holding member 20, and a second pinching member 18 coupled to the first pinching member 16. As shown in FIG. 1, the first pinching member 16 is cylindrical, and the second pinching member 18 is curved so as to fit the surface of the first pinching member 16. The first pinching member 16 is provided with a handle 26, a front stand 24, and a central stand 25. A cool chip 15 is arranged at the tip of the first pinching member 16, a plurality of air vent openings 28 are arranged on the side thereof, and the holding member 20 and a power cord 32 are arranged at the lower portion thereof. Power switches 30 are arranged on the upper surface of the holding member 20 (see FIG. 2 A), and a control board 36 is arranged next to the power switches 30 (see FIG. 8). In FIG. 2 B, the dimensions of each part of the curl iron are shown in mm. The length from the tip of the cool chip 15 to the connection portion of the holding member 20 and the power cord 32 is 341 mm, the height of the cool chip 15 is 32 mm, and the length of the holding member 20 is 193.5 mm.

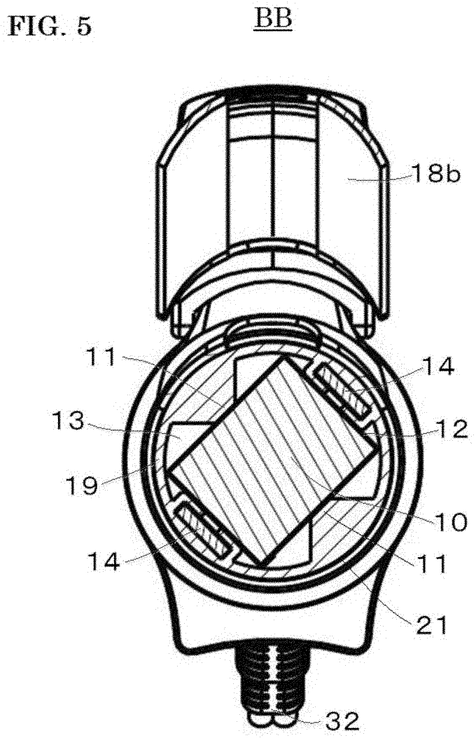

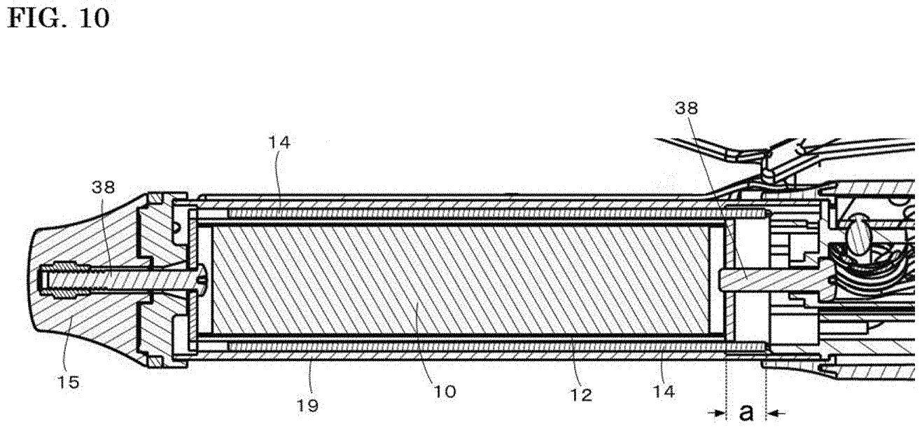

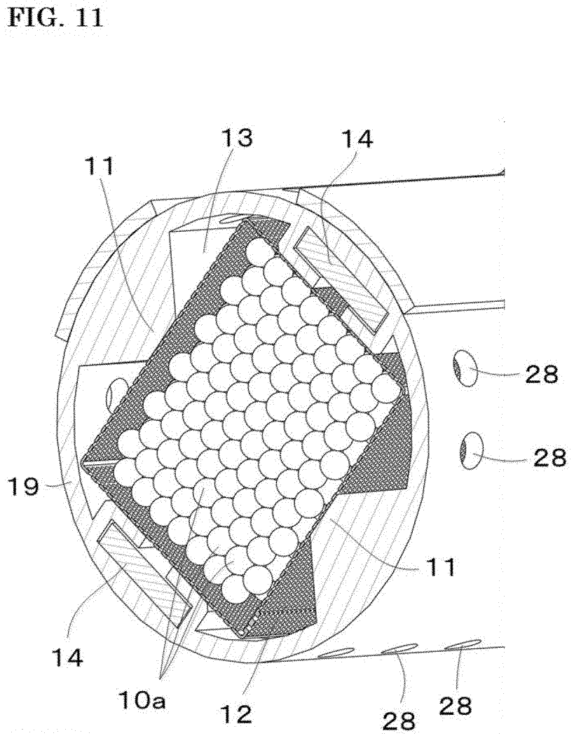

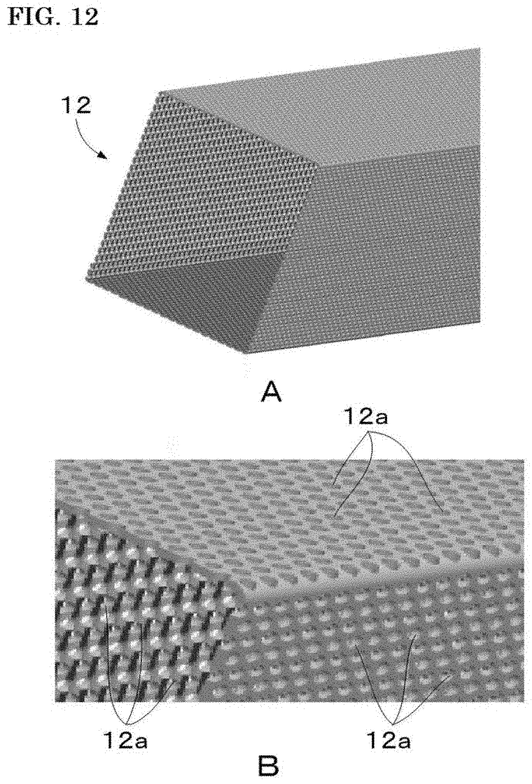

As shown in FIG. 10, the curl iron of the present invention includes a heater 14 and a desiccant holding container 12 for holding the desiccant 10 in a housing 19. As shown in the cross-sectional view of FIG. 5, the two heaters 14 are arranged on both sides of the short side of the desiccant holding container 12 so as to face each other with a distance from the desiccant holding container 12. The heater 14 may be arranged directly on the desiccant holding container 12 without interposing the housing 19. The dimensions of the heater 14 are 1.8 mm×8.7 mm, and the length in the longitudinal direction is 108 mm. The desiccant holding container 12 is formed by bending a 0.2 mm thick stainless steel punching metal plate into a rectangular parallelepiped. Measured by the inner diameter, the size of the cross section crossing the longitudinal direction is 16.6 mm×21.2 mm, and the length in the longitudinal direction is 106 mm. As a part thereof is shown in FIG. 12, a large number of holes 12a are formed on all surfaces of the desiccant holding container 12. The diameter of the holes 12a of the desiccant holding container 12 is set in such a way that the desiccant particles 10a (see FIG. 11) held in the desiccant holding container 12 and fragments thereof cannot pass through. In this embodiment, a diameter of 0.3 mm is adopted. In the present invention, the punching metal refers to a metal plate in which holes are formed by press working, etching treatment (chemical treatment), laser processing, or the like. A metal mesh such as a stainless-steel mesh can be used instead of the punching metal. In the embodiment 1, the desiccant holding container 12 is a rectangular parallelepiped, but instead of this, a cylindrical or polygonal container can also be used.

As the desiccant particles 10a, zeolite beads manufactured by Tokai Chemical Industry Co., Ltd. having a particle size of 1.41-2.38 mm are used. In the desiccant holding container 12, an amount of 30 g of desiccant particles 10a is held so as to fill the container. The particle size of the desiccant particles 10a is preferably 1.4-2.5 mm, but is not limited thereto. When the particle size is small, the desiccant particles 10a can be ejected from the desiccant holding container 12, and when the particle size is large, the workability may be deteriorated in case the desiccant particles 10a are filled in a narrow space in the case of a straight iron.

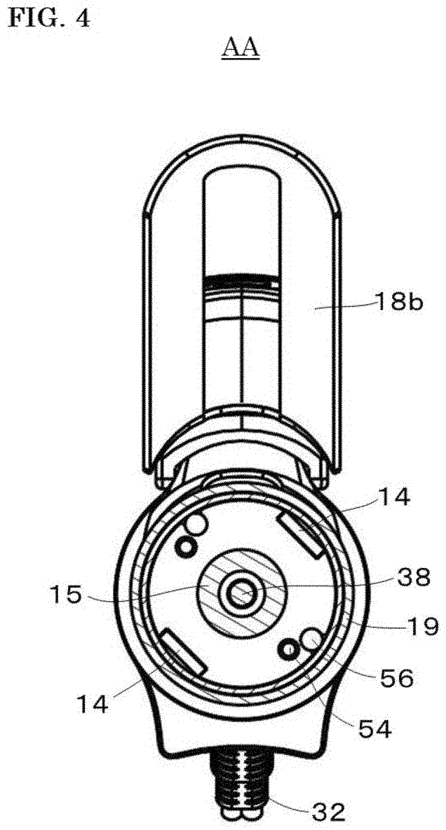

FIGS. 4, 5, and 6 are respectively the cross-sectional views corresponding to the cross-sectional lines AA, BB, and CC in FIG. 3. FIG. 4 shows the second pinching member 18b, the lowermost component of the cool chip 15 composed of three components, the upper end of the heater 14, a fixing screw 38, a screw hole 54 for fixing the sheet metal that receives the screw head of the fixing screw 38 to the first pinching member, an insertion hole 56 for inserting a temperature control component (NTC), and the housing 19.

FIG. 5 shows that the desiccant holding container 12 for holding the desiccant 10 is supported by two convex portions 11 arranged on the housing 19. FIG. 5 also shows two heaters 14 installed in the heater holding member in the housing 19, and a space portion 13 through which air going through the air vent openings 28 passes. Further, a hair treatment surface 21 which is the outer surface of the first pinching member 16 is also shown in FIG. 5.

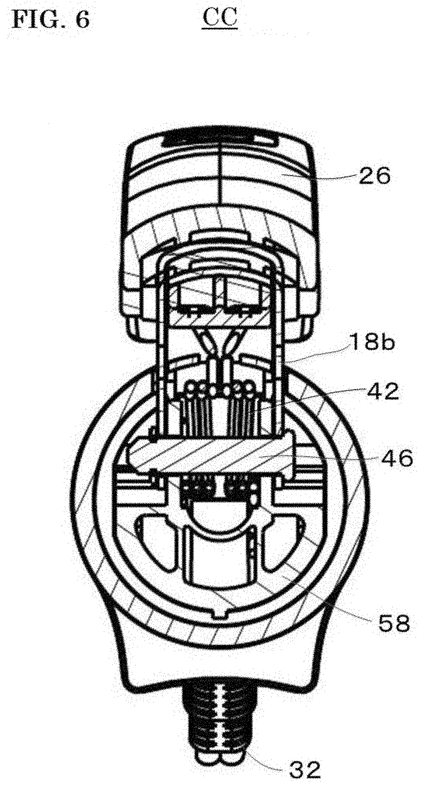

FIG. 6 shows a second pinching member 18b being separated from the first pinching member 16, the rotating shaft 46 of the second pinching member 18, the torsion coil spring 42 for giving a force to return the second pinching member 18 to the position of the second pinching member 18a, and a fixing component 58 for connecting the second pinching member 18 and the handle 26. The fixing component 58 is part of an internal plastic product.

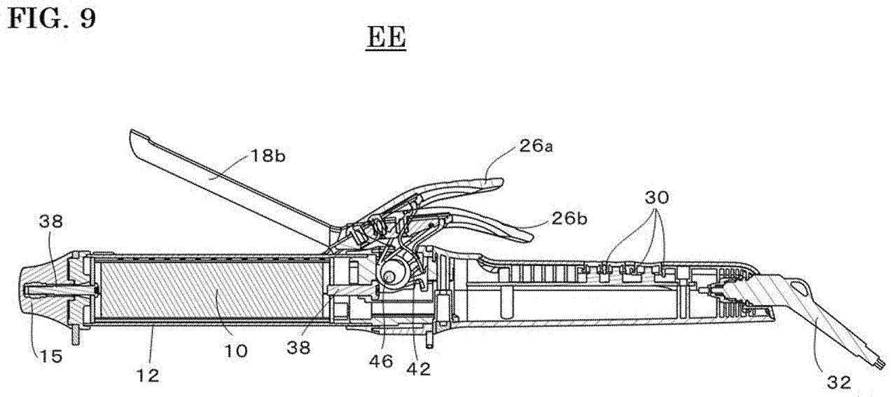

As shown in FIG. 9, the second pinching member 18 and the handle 26 are rotatably fixed to the first pinching member 16 by the rotating shaft 46 and the torsion coil spring 42. As shown in FIGS. 1 and 3, when the curl iron is not in use, the handle 26 and the second pinching member 18 are respectively in positions of the handle 26a and the second pinching member 18a. When the user pushes down the handle 26, the handle 26 and the second pinching member 18 move respectively to the positions of the handle 26b and the second pinching member 18b, so that the user can pinch the hair between the first pinching member 16 and the second pinching member 18b.

As shown in FIGS. 1 and 2, the housing 19 constituting the first pinching member 16 is provided with four sets of 2×14 air vent openings 28. The air vent openings 28 take in air from the outside into the first pinching member 16 and discharge heated air which contain moisture generated from the desiccant 10 heated by the heater 14. The diameter of the air vent openings 28 is 2.5 mm. Since the air vent openings 28 communicate with the space portion 13 shown in FIG. 5, the air from the outside reaches the desiccant 10 held in the holding container 12 via the air vent openings 28 and the space portion 13, so that the warm air containing moisture generated from the desiccant 10 heated by the heater 14 is discharged to the outside of the curl iron through the space portion 13 and the air vent openings 28.

Next, the operation of the curl iron according to the embodiment 1 will be described. When the user turns on the power switches 30, the heater 14 is energized via the power cord 32 and the control board 36. When the heater 14 is heated, air is taken in from the air vent openings 28. On the other hand, when the desiccant particles 10a arranged in the desiccant holding container 12 become 150° C. or higher due to the heating of the heater 14, moisture is released from the desiccant particles 10a. The released moisture is blown out from a plurality of air vent openings 28 arranged on the surface of the housing 19 of the first pinching member 16, through a large number of holes 12a (see FIG. 12) of the desiccant holding container 12 formed of punching metal or the like, and supplied to the user's hair.

The desiccant particles 10a can supply moisture to the hair for at least 60 minutes per use. When the user finishes using the curl iron and turns off the power switches 30, the temperature of the desiccant particles 10a drops and the desiccant 10 starts absorbing moisture in the air. Since the desiccant particles 10a can absorb (regenerate) 20% by weight of moisture in 24 hours, the user can use the curl iron the next day. That is, the user can use the curl iron every day for at least 60 minutes without the tedious task of storing water in the liquid reservoir as in conventional hair care apparatuses. The operating temperature of the curl iron can be set by the switches 30. Since the desiccant 10 efficiently generates moisture when its temperature exceeds 150° C., the operating temperature of the curl iron is set so that the temperature of the desiccant 10 exceeds 150° C. The operating temperature may be maintained at the set temperature by the temperature control component (NTC).

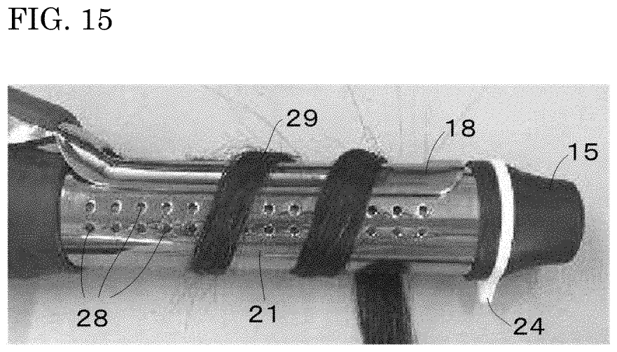

To use the curl iron, the user pushes the handle 26 (26b in FIG. 2 B) to open the second pinching member 18 (18b in FIG. 2 B), and sandwiches the hair between the first pinching member 16 and the second pinching member 18. Then, as shown in FIG. 15, the user rolls the hair 29 around the hair treatment surface 21 consisting of the outer peripheral surface of the first pinching member 16 and the second pinching member 18 for its heat-treatment. The user can obtain curled hair by holding the state in which the hair 29 is rolled around the hair treatment surface 21 for a while. When rolling the hair around such surface, the user can also rotate the curl iron by holding the holding member 20 and the handle 26 with the right hand and pinching the cool tip 15 with the left hand. The cool chip 15 is configured such that the contact area with the fingers is small so that it causes no problem even if the fingers pinch the cool chips 15.

Since the first pinching member 16 and the second pinching member 18 are heated to a high temperature of 140° C. or higher during use, if the curl iron is carelessly placed on a desk, there is a risk that the desk burns or melts. To eliminate this risk, the curl iron is provided with the front stand 24 and the central stand 25. As a result, even if the user places the curl iron on a desk or the like during use, the curl iron does not come into direct contact with the desk.

In the curl iron of the embodiment 1, the two heaters 14 are arranged, facing each other, between the desiccant holding container 12 and the inside of the housing 19 provided with the air vent openings 28 (FIG. 5), and in the longitudinal direction of the desiccant holding container 12 (FIG. 8). Further, the desiccant is composed of desiccant particles 10a, and the desiccant particles 10a are held in the desiccant holding container 12 formed of a punching metal or the like having innumerable holes 12a. Therefore, as compared with the hair iron of the patent document 2 in which the heater is arranged in the center of the hair iron and the desiccant is arranged around the heater, the heat of the heater 14 reaches the desiccant particles 10a through the holes 12a of the punching metal in a shorter time. Further, since the desiccant is a particle, the surface area of the entire desiccant increases, and the heat exchange efficiency with respect to the desiccant is improved. As shown in FIG. 10, by projecting the heater 14 outward from the desiccant holding container 12 by a distance “a” (8 mm), the heat exchange efficiency with respect to the desiccant can be improved as compared with the curl iron in which the heater 14 does not project. In FIG. 10, the projected portion “a” of the heater 14 is on the right side of the desiccant holding container 12, but this may be arranged on the left side of the desiccant holding container 12.

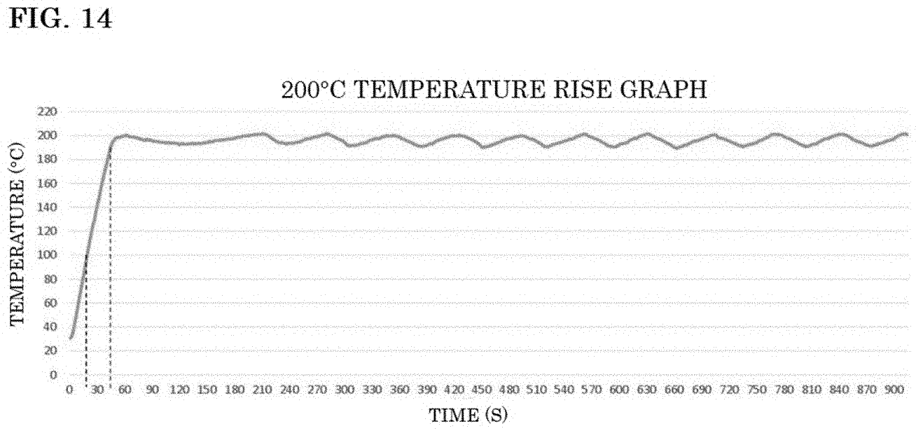

As a result of the improved heat exchange efficiency with respect to the desiccant, the curl iron of the embodiment 1 no longer requires a blower fan. That is, in the conventional hair iron described in the patent document 2, if the blower fan is not operated, it takes more than 2 minutes to reach the operating temperature of 190° C. from turning on the power. In contrast, in the hair iron of the embodiment 1 which does not have the blow fan, it takes only 45 seconds to reach the operating temperature of 190° C., which will be described later with reference to FIG. 14.

In the conventional hair iron described in the patent document 2, since the heater is arranged at the center, it has a problem that moisture is already wasted until the surface of the first pinching member is heated to the operating temperature. On the other hand, in the curl iron of the embodiment 1, since the heater 14 is arranged between the outside of the desiccant holding container 12 and the inside of the housing 19, no moisture is wasted from the desiccant until the surface of the first pinching member is heated to the operating temperature. Further, since the desiccant is made into particles, it is not necessary to use the desiccant shaped into a plate or the like in the curl iron of the embodiment 1, so that an inexpensive desiccant can be used.

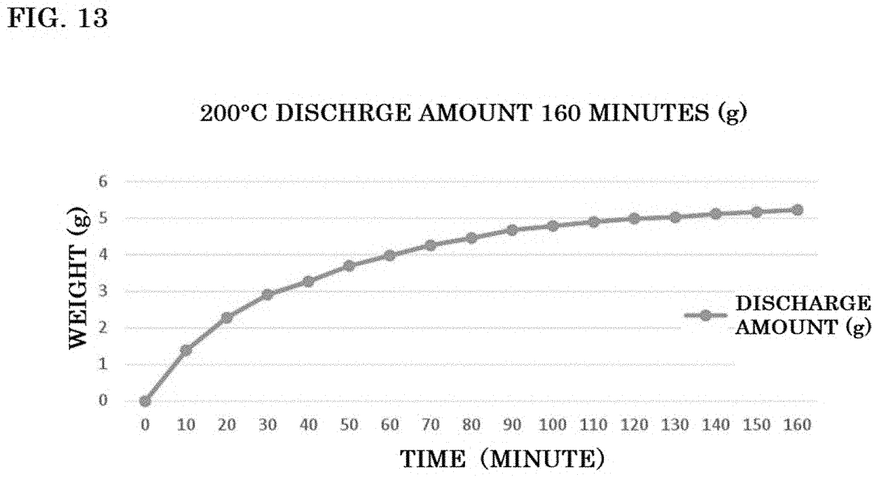

FIG. 13 shows characteristic data regarding the discharge amount of the curl iron of the embodiment 1. This is a plot of the total amount of moisture released by this curl iron over time. From this characteristic data, it can be seen that after 160 minutes, the total amount of moisture released by this curl iron is 5.2 g. This moisture content indicates that the curl iron is sufficiently practical.

FIG. 14 is characteristic data showing the temperature rise of the curl iron of the embodiment 1 to 200° C. This shows the temperature change of the surface of the first pinching member 16 over time. From this characteristic data, it can be seen that in the curl iron of the embodiment 1, the surface temperature of the first pinching member 16 reaches 190° C. in only 45 seconds after the power is turned on. It is a very great effect, compared with the conventional hair iron described in the patent document 2, which requires 2 minutes or more from turning on the power to reaching the operating temperature of 190° C. without operating the blower fan.

### Embodiment 2

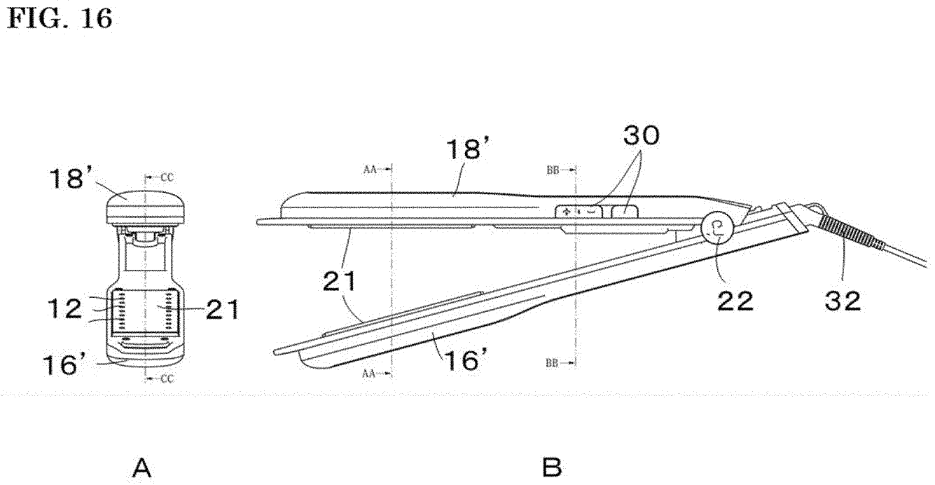

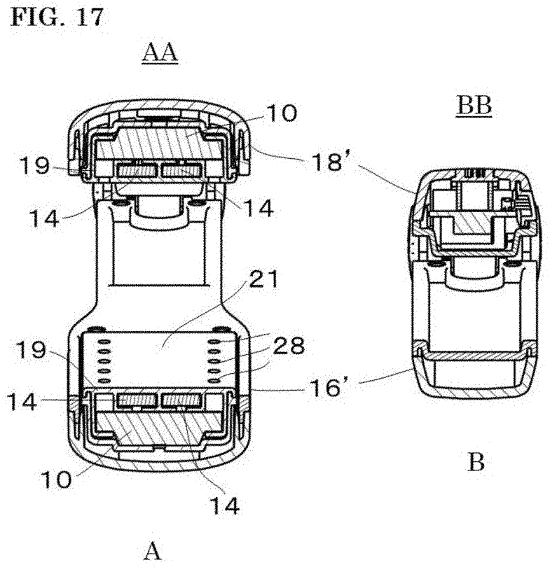

An example of using the hair care apparatus of the present invention as a straight iron will be described below. In the following description, the description which is common to the curl iron of the embodiment 1 will be omitted. As shown in FIG. 16B, the straight iron of the embodiment 2 includes a first pinching member 16′ and a second pinching member 18′ connected by a hinge member 22. In the curl iron, the contact surface between the first pinching member 16′ and the second pinching member 18′ that sandwiches the hair is curved, while in the straight iron, the contact surface is flat as shown in FIG. 17.

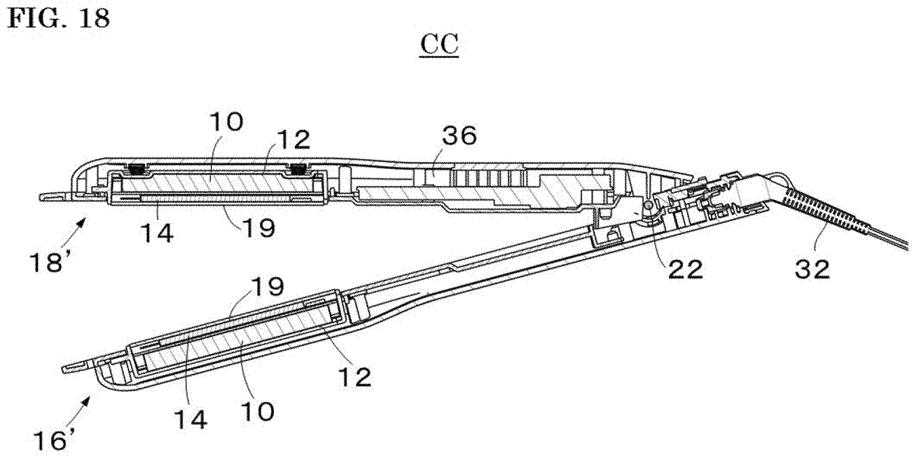

As shown in FIG. 18, both the first pinching member 16′ and the second pinching member 18′ include a heater 14, a desiccant holding container 12, and a desiccant 10 consisting of desiccant particles 10a in the housing 19 thereof. As shown in FIG. 17 A, the air vent openings 28 are arranged on the hair treatment surface 21 of the housing 19. Although not shown in FIG. 17 A, the second pinching member 18′ also has the air vent openings 28. In each of the first pinching member 16′ and the second pinching member 18′, the heater 14 is arranged inside the air vent openings 28, and a desiccant holding container 12 is arranged inside the heater 14. The second pinching member 18′ is provided with a control board 36 (FIG. 18) and the switches 30 (FIG. 16).

The straight iron of the embodiment 2 operates in the same manner as the curl iron of the embodiment 1. When the user turns on the power switches 30, the heaters 14 of the first pinching member 16′ and the second pinching member 18′ are energized via the power cord 32 and the control board 36. When the heaters 14 are heated, air is taken in from the air vent openings 28. On the other hand, when the desiccant particles 10a arranged in the desiccant holding container 12 of the first pinching member 16′ and the second pinching member 18′ become 150° C. or higher due to the heating of the heater 14, moisture is released from the desiccant particles 10a. The released moisture passes through a large number of holes 12a (see FIG. 12) of the desiccant holding container 12 made of punching metal or the like is blown out from a plurality of air vent openings 28 arranged on the hair treatment surface 21 of the first pinching member 16′ and the second pinching member 18′, and supplied to the user's hair. As described above, in the straight iron of the embodiment 2, the user's hair is sandwiched and heat treated by the hair treatment surface 21 (FIG. 17) arranged on the first pinching member 16′ and the second pinching member, which allows the user to obtain straight hair.

In the above descriptions, the hair care apparatus of the present invention have been described by taking a curl iron and a straight iron as examples, but it goes without saying that the hair care apparatus of the present invention can be applied not only to this but also to a roll brush and the like.

### REFERENCE SIGN LIST

10 Desiccant

10a Desiccant particles

11 Convex portion

12 Desiccant holding container

12a Desiccant holding container holes

13 Space portion

14 Heater

15 Cool chip

16 First pinching member

16′ First pinching member (a straight iron)

18 Second pinching member

18a Second pinching member (closed state)

18b Second pinching member (open state)

18′ Second pinching member (a straight iron)

19 Housing

20 Holding member

21 Hair treatment surface

22 Hinge member

24 Front stand

25 Central stand

26 Handle

26a Handle (closed state)

26b Handle (open state)

28 Air vent openings

29 Hair

30 Power Switches

32 Power cord

36 Control board

38 Fixing screw

42 Torsion coil spring

46 Rotating shaft

54 Screw hole

56 Insertion hole

58 Fixing component

1. A hair care apparatus comprising:
a first and second pinching members for pinching hair;
a desiccant holding container;
a reproducible desiccant held in the desiccant holding container; and
a heater;
wherein the heater is arranged on the hair treatment surface side of the desiccant holding container in the longitudinal direction of the desiccant holding container,
wherein the desiccant is granular, and
wherein the entire surface of the desiccant holding container is arranged with a plurality of holes through which the desiccant and fragments of the desiccant cannot pass.

2. The hair care apparatus according to claim 1, wherein the desiccant holding container is made of a stainless mesh.

3. The hair care apparatus according to claim 1, wherein the desiccant holding container is made of a punching metal.

4. The hair care apparatus according to claim 1, wherein the desiccant has a particle size of 1.4 to 2.5 mm.

5. The hair care apparatus according to claim 1, wherein the heater protrudes from the desiccant holding container.

6. The hair care apparatus according to claim 1, wherein the desiccant comprises zeolite.

7. The hair care apparatus according to claim 1, wherein the desiccant comprises alumina and silica.

8. The hair care apparatus according to claim 1, wherein the desiccant comprises silica gel.

9. The hair care apparatus according to claim 1, wherein the desiccant comprises a clay-based desiccant.

10. The hair care apparatus according to claim 1, which can be set so that the temperature of the desiccant is 150° C. or higher at the time of use.

11. The hair care apparatus according to claim 1, wherein the hair care apparatus is a curl iron.

12. The hair care apparatus according to claim 1, wherein the desiccant holding container and the heater are straight irons arranged in the first pinching member and the second pinching member, respectively.
